(19) United States
(12) Patent Application Publication
(10) Pub. No.: US 2012/0030101 A1
(43) Pub. Date: Feb. 2, 2012

(54) VENDOR PAYMENT CONSOLIDATION SYSTEM

(75) Inventor: Michael Boyd, Los Gatos, CA (US)

(73) Assignee: APPLE INC., Cupertino, CA (US)

(21) Appl. No.: 13/250,892

(22) Filed: Sep. 30, 2011

Related U.S. Application Data
(63) Continuation of application No. 12/899,236, filed on Oct. 6, 2010.
(60) Provisional application No. 61/249,193, filed on Oct. 6, 2009.

(51) Int. Cl. G06Q 20/22

(52) U.S. Cl. 705/40

(57) ABSTRACT

Several related entities can owe payments to a single vendor. For example, several related companies can owe payments to developers who sell software using several storefronts operated by the related companies. To limit the number of payments made to the developer, a third-party payment processing entity can receive individual payments from each of storefronts for a developer, can aggregate the payments and convert their respective currencies if necessary, and provide a single payment on behalf of all of the storefronts to the developer. Because the payment processing entity is a third party (e.g., a bank) and not related to the storefronts, the tax or other advantages procured from having several storefronts can be preserved while reducing the costs of paying the developer (e.g., fewer transaction fees).

### CROSS-REFERENCE TO RELATED APPLICATION

This application claims the benefit of U.S. Provisional Patent Application No. 61/249,193, filed on Oct. 6, 2009, entitled “Vendor Payment Consolidation System,” and which is incorporated herein in its entirety.

### BACKGROUND

This is directed to a system for simplifying and streamlining payments from several legal entities all associated with a single vendor to a payee. In particular, this is directed to using a third party payment processor for aggregating payment obligations and remitting a single payment to the payee.

Some large companies or vendors, and in particular companies conducting business in many different countries and in several different currencies, create several legal entities each based in different jurisdictions to deal with financial and transactional matters for each jurisdiction or for nearby jurisdictions. In addition, some companies can set up different legal entities in different jurisdictions to maximize savings due to differences in tax laws. For example, a multi-national company can include legal entities in the United States, Europe (e.g., in France), Canada, Australia and Japan. Each of those entities can independently conduct transactions, including receiving payments and remitting payments.

In some cases, a single vendor can conduct transactions with large companies having several legal entities. While in some cases the single vendor can deal with only one of the legal entities, in other cases the vendor may conduct distinct transactions with some or all of the several legal entities. This can require several distinct transfers of funds between the large company and the vendor, each of which can be associated with transaction fees or other undesired charges. In addition, this can require complex or extensive accounting to ensure that all payments are made by each legal entity in a timely fashion.

### SUMMARY

This is directed to a system by which a third party payment entity receives several transactions to be conducted between several legal entities associated with a parent entity and a vendor, aggregates the transactions, converts the transactions to a single appropriate currency, and conducts the single transaction with the vendor on behalf of the several legal entities.

Large commercial entities can create several legal entities in different jurisdictions for conducting business. In particular, a large commercial entity can include several wholly or partially owned subsidiaries created in one or more jurisdictions. For example, a commercial entity can include different subsidiaries created in different jurisdictions to conduct business in each of the jurisdictions while taking advantage of local tax regulations or of local currencies (e.g., avoiding fees associated with converting from a commercial entity's primary currency to a currency of the local jurisdiction.

The commercial entity can conduct business with one or more vendors or suppliers, who in turn can provide goods or services to the commercial entity. In some cases, a single vendor or supplier can provide goods which in turn are sold by several of the subsidiaries, who consequently each may have legal obligations to the vendor upon reselling the goods. For example, a commercial entity can provide an applications store for selling software applications, or other digital content such as games, interactive media, e-books, a key or license for accessing content (e.g., an access key that a user can purchase to access content provided by a content provider, such as a subscription to a website), or other media to end-users or consumers (e.g., for use on portable electronic devices such as mobile telephones, on other mobile devices such as personal digital assistants, game consoles, or computers generally, such netbook, laptop, desktop, or personal computers). The applications store can be supported by several subsidiaries, such that each subsidiary operates a storefront for a particular jurisdiction. An application developer can sell an application to consumers in every jurisdiction via the storefronts operated by each of the subsidiaries. When a consumer purchases the application from a particular storefront, the subsidiary associated with the storefront may incur a legal obligation to pay a fee to the developer (e.g., 70% of the sales price). Similarly, each subsidiary associated with each of the storefronts from which the application is sold may incur a legal obligation to pay the developer. To discharge these legal obligations, each of the subsidiaries may be required to pay the developer a different amount.

In some cases, the developer/content provider and each of the subsidiaries may conduct transactions using different currencies. For example, each storefront and associated subsidiary may be associated with one or more currencies, and the developer may wish to be paid by the commercial entity in a single particular currency. Each subsidiary may then be required to individually convert payments before remitting them to the developer.

While this system does allow each developer to receive the appropriate payments, it can be confusing to the developer as he may receive several payments from several subsidiaries. In addition, the commercial entity and the subsidiary may be subject to several transaction fees (e.g., at least one for each of the payments to be remitted). One solution for reducing the number of payments to be made can include transferring all payments to be made from the subsidiaries to the corporate entity, a new subsidiary, or one of the subsidiaries to serve as the payment center for the corporate entity. This approach, however, can negate the tax advantages that were the onus for creating the several subsidiaries, as funds may be transferred among the subsidiaries.

An alternate approach can include using a third-party payment processing entity to aggregate the payments to be made by each of the several subsidiaries, and remit a single payment for the corporate entity to the vendor (e.g., the developer). Because the payment processing entity is a third party (e.g., a bank) and not related to the corporate entity, the initial payments made by each subsidiary to the payment processing entity can have limited fees while preserving the tax advantages of each of the subsidiaries. In addition, the vendor can receive a single payment from the processing entity in a single currency, and rely on the processing entity to convert payments received in different currencies from each of the subsidiaries to the currency requested by the vendor.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a schematic view of an illustrative company structure in which several subsidiaries can have obligations to a vendor in accordance with one embodiment of the invention;

FIG. 2 is a schematic view of an illustrative window used in an electronic device in accordance with one embodiment of the invention; and

FIG. 3 is a flowchart of an illustrative process for applying a dichroic coating to a glass window for creating a particular cosmetic effect in accordance with one embodiment of the invention.

### DETAILED DESCRIPTION

A corporate entity can include several subsidiaries conducting business in different jurisdictions using one or more currencies. In some cases, a single vendor can conduct transactions with more than one of the several subsidiaries, such that more than one of the subsidiaries owes payment to the vendor. To reduce or limit the number of payments made to the vendor, a third-party payment processing entity can aggregate the payment information due to vendor from each of the subsidiaries, and provide a single aggregated payment to the vendor on behalf of the subsidiaries.

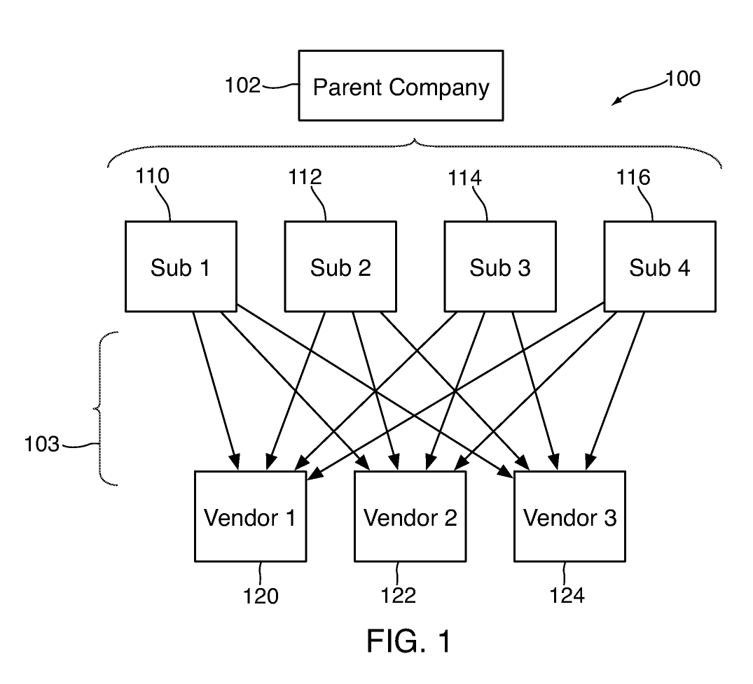

FIG. 1 is a schematic view of an illustrative company structure in which several subsidiaries can have obligations to several vendors in accordance with one embodiment of the invention. System 100 can include parent company 102 having several subsidiaries through which the parent company can interact with different vendors. Parent company 102 can have any suitable number of partially or wholly owned subsidiaries, including for example subsidiaries 110, 112, 114 and 116. Each subsidiary can conduct transactions with one or more vendors, and in some cases a single vendor can transact with several subsidiaries. In the example of FIG. 1, vendors 120, 122 and 124 each conduct transactions 130 with each of subsidiaries 110, 112, 114 and 116, though it will be understood that any suitable combination of transactions between the vendors and subsidiaries can exist. In some cases, a vendor can even conduct transactions directly with parent company 102 (not shown).

Parent company 102 can create subsidiaries based on any suitable criteria. For example, parent company 102 can create partially owned or wholly owned subsidiaries in different jurisdictions. For example, the parent company can identify particular jurisdictions in which it does business and for which there are advantages to be locally owned (e.g., tax or fiscal advantages, or business advantages with respect to vendors). As another example, the parent company can create different subsidiaries each operating with different currencies.

Using the scheme of system 100, each vendor can conduct several transactions with different subsidiaries of the parent company. For example, each vendor can receive several payments from different subsidiaries, in one or more currencies. This can be confusing to a vendor, who may think he is dealing only with the parent company, and may only wish to receive payments in a single currency. In addition, the subsidiaries or the vendors may be subject to additional transaction fees, as each individual transaction can be associated with a fee.

To simplify the payment scheme, the subsidiaries can all transfer funds to cover their obligations to the vendors to a particular subsidiary or to the parent company, so that the particular subsidiary or the parent company handles all transactions with the vendor, but this approach may negate the benefits (e.g., tax and fiscal advantages) that the multi-subsidiary scheme provided. In some embodiments, the parent company can instead implement another approach for simplifying the payment scheme while ensuring that the benefits of the multi-subsidiary system are maintained. In particular, the parent company can use a third-party entity not controlled or owned by the parent company as an intermediary for conducting transactions with each vendor. The subsidiaries having obligations to one or more vendors can provide a report describing the obligation to the third-party entity, and direct the third-party entity to aggregate the obligations. The third-party entity can then provide a single payment to each vendor in an amount equal to the aggregated obligations.

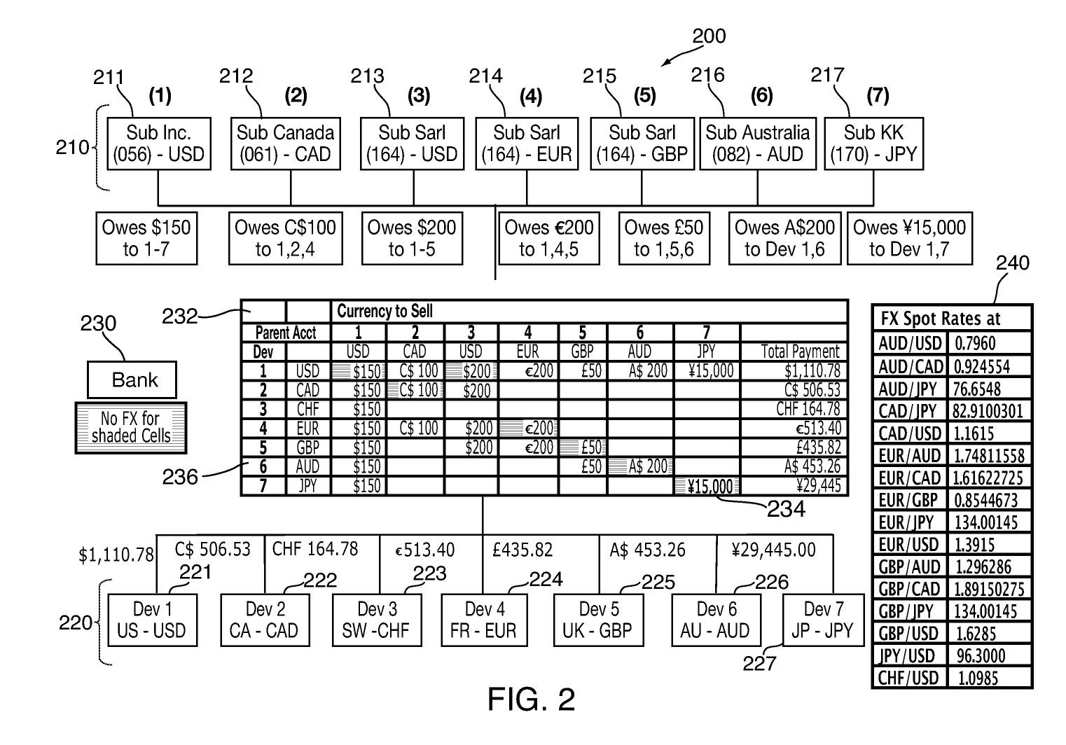

FIG. 2 is a schematic view of an illustrative system for paying several vendors using a third-party entity in accordance with one embodiment of the invention. For the simplicity of the discussion, system 200 will be described in the context of a parent company having several subsidiaries making payments to developers using the subsidiaries to distribute software created by the developers. For example, each developer can select to distribute software via storefronts operated by individual subsidiaries of the parent company, where each storefront and each subsidiary can be tied to a particular geographic location and a particular currency. A parent company can include subsidiaries and storefronts in any suitable jurisdiction, including for example in Canada (Canadian dollars), Australia (Australian dollars), Japan (Yen), Europe (Euros, pounds and US dollars), and the rest of the world (US dollars). For simplicity and accounting, a parent company subsidiary may not make any payments to a developer until the developer has reached a minimum threshold at which the payment transaction becomes financially viable (e.g., the transaction fees minimally impact the transaction). It will be understood, however, that the scheme and system described in connection with FIG. 2 can be used for any other payment scheme, including any other system in which several commonly owned or commonly controlled entities owe payments to a single party.

System 200 can include collection 210 of related entities having legal payment obligations to some of collection 220 of developers. For example, each of paying entities 211, 212, 213, 214, 215, 216 and 217 can owe payments to at least one of developers 221, 222, 223, 224, 225, 226 and 227. The entities of collection 200 can be related in any suitable manner. For example, they can all be subsidiaries of a single parent entity. As another example, one of the entities can be a parent entity for the other entities. As still another example, the entities of collection 200 can be all ultimately related to a single common entity (e.g., an ultimate parent entity). In some embodiments, the paying entities can include a processor or other machine or machine element for providing transaction information or performing transactions required for providing payments to payees. In addition, the payee entities can include a processor or other machine or machine element for performing transactions required for receiving payments from the paying entities.

Each entity of collection 210 can determine the payment obligations owed to individual developers using any suitable approach. In some embodiments, each entity can review the sales from the storefront associated with the entity, and identify the sales associated with each developer. Each entity can then determine the percentage of the sales to return to the developers (e.g., 70%). Instead of each entity then paying the individual developers their payments due, the entities can each provide the accounting associated with each developer to payment processing entity 230. The individual accountings can be provided in any suitable currency. In some embodiments, each entity of collection 210 can be associated with storefronts having a particular currency. The resulting accounting provided to payment processing entity 230 can be generated in the particular currency associated with each paying entity of collection 210. Alternatively, each paying entity 210 can instead or in addition provide a payment in the amount and currency determined for each developer 220 to payment processing entity 230.

Payment processing entity 230 can include any suitable payment processing entity that is unrelated to any of the entities of collection 200. For example, payment processing entity 230 can include a third party entity for receiving payments from a first party and transferring payments to a second party (e.g., a bank). In some embodiments, the payment processing entity can include a processor or other machine or machine element for performing the aggregation and transactions required for providing payments to payees. In some cases, payment processing entity 230 can convert funds to different currencies or can hold funds for a particular vendor. Payment processing entity 230 can charge one or both of paying entities 210 and developers 220 using any suitable approach, including for example a flat fee, a per-transaction fee, a currency conversion fee, or any other suitable type of fee.

In response to receiving payments, accountings or both from each paying entity 210, payment processing entity 230 can aggregate the payments received from each entity 210 and determine the total amount to pay to each developer 220. For example, payment processing entity 230 can generate table 232 depicting the payments received from each entity 210 in columns 234 and the payments due to each developer 220 in rows 236. Because each paying entity 210 can provide payments in different currencies, payment processing entity 230 may be required to convert or adjust currencies as part of the aggregation process.

Once payment processing entity 230 has determined how much should be paid to each developer, the payment processing entity can determine the particular currency in which to pay each developer. Each developer, upon signing up with the paying entities to distribute software created by the developer, can select a currency in which the developer wishes to be paid. If the selected currency is supported by the payment processing entity, the payment processing entity can convert the received payments to the developer's selected currency. Alternatively, the payment processing entity can convert the payments to a default currency and provide payment to the developer in the default currency. The payment processing entity can use any suitable source for determining the rates at which to convert received funds (e.g., rates 240). In some cases, the payment processing entity can use an average rate or rate determined at a particular time (e.g., the rate on the 15^{th} of the month, or the average, highest or lowest rate in the month), or the payment processing entity can determine the current or real-time rate at the time either payment is received from the paying entity or at the time payment is made to the developer.

The payment processing entity can then make a single payment on behalf of all of the paying entities to each developer. The single payment can be identified as being from any suitable source, including for example a generic name or specific name selected by one or more of the paying entities (e.g., payment from the Apple Developer Program).

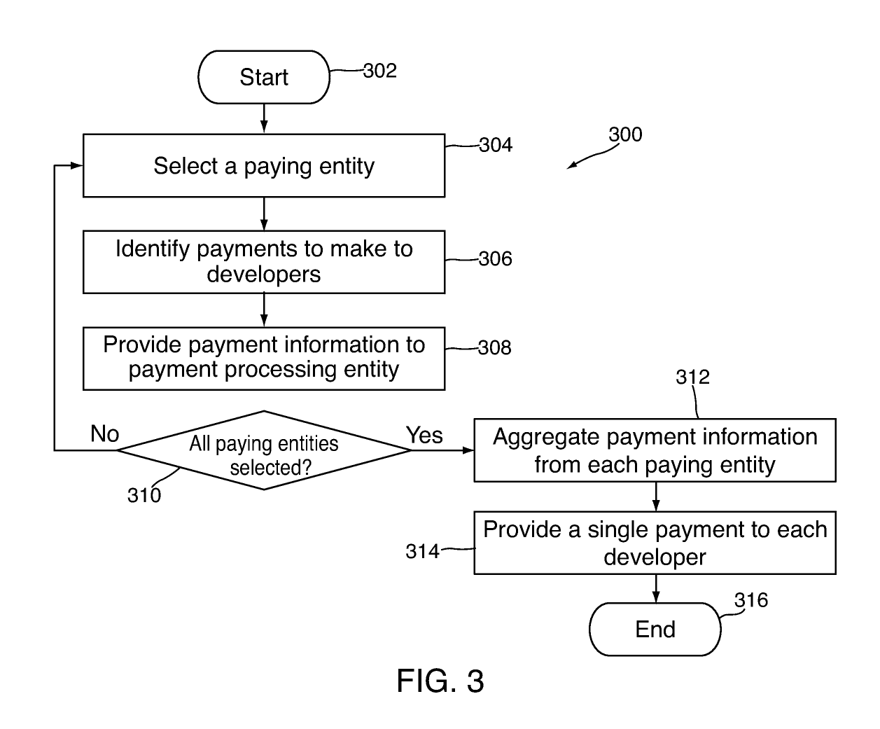

FIG. 3 is a flowchart of an illustrative process for paying developers in accordance with one embodiment of the invention. Process 300 can begin at step 302. At step 304, a paying entity can be selected (e.g., by an automated processing system). In particular, one of several paying entities all related to a single company can be selected. For example, one of several companies supporting a storefront for selling applications created by developers can be selected. At step 306, the payments due to each developer by the selected paying entity can be identified (e.g., by an automated processing system). For example, the paying entity can review the sales figures for each developer, and determine the amount of the sales that is to be returned to each developer (e.g., 70% of the sales for the developer's applications).

At step 308, the paying entity can provide information specifying the payments due to each developer to a payment processing entity. For example, the paying entity can provide a spreadsheet or other document defining the payment amounts and currencies for each developer. In some embodiments, the paying entity can instead or in addition provide payments to the payment processing entity that the payment processing entity can in turn transfer to the developer. The payment provided by the paying entity can include a single lump-sum payment covering the paying entities payments to all of the developers, or can instead include several individual payments each associated with a particular developer or application title. The paying entity can provide payments in one or more currencies, including for example the currency of the associate storefront, the currency associated with the paying entity, or a currency associated with developers.

At step 310, the process can determine whether all of the paying entities have been selected (e.g., using an automated processing system). For example, the process can determine whether all of the paying entities associated with a parent company have provided their developer payment information to the payment processing entity. If at least one paying entity has not been selected, process 300 can return to step 304 and select another paying entity. If, at step 310, all of the paying entities have been selected, process 300 can move to step 312.

At step 312, the payment processing entity can aggregate payment information from each payment entity to determine the payment amount due to each developer. If the payment information provided by the paying entities includes payments in several currencies, the payments can be converted to a single currency by the payment processing entity. Any suitable currency can be used, including for example a default currency used by the payment processing entity or a currency selected by each developer. The payment processing entity can then identify a single payment due to each developer. At step 314, the payment processing entity can provide the single payment to each developer in the desired currency. In some embodiments, the payment processing entity may provide payment only when the payment amount exceeds a minimum threshold. For example, the payment processing entity may provide a payment only when the payment amount is more than $50, or its equivalent in other currencies. This may ensure that charges or fees of the payment processing entity do not dilute the payment. Process 300 can then end at step 314.

The previously described embodiments are presented for purposes of illustration and not of limitation. It is understood that one or more features of an embodiment can be combined with one or more features of another embodiment to provide systems and/or methods without deviating from the spirit and scope of the invention. The present invention is limited only by the claims which follow.

What is claimed is:

1. A method for providing a payment to a common payee from a plurality of related paying entities, comprising:
determining a payment amount due by each of a plurality of paying entities to a common payee using an automated processing system, wherein each of the plurality of paying entities are controlled by a single legal entity;
providing the determined payment amounts for each of the paying entities to a third-party payment processing entity using an automated processing system, wherein the single legal entity does not control the payment processing entity;
directing the payment processing entity to aggregate the determined payment amounts to define a single total amount due to the payee; and
directing the payment processing entity to remit payment to the payee in the single total amount.

2. The method of claim 1, wherein:
each of the plurality of paying entities is associated with a particular currency; and
providing the determined payment amounts comprises providing the determined payment amounts in the currencies associated with each of the corresponding paying entities; and
directing the payment processing entity to convert the provided payment amounts to a single currency.

3. The method of claim 2, wherein:
the single currency is selected by the payee.

4. The method of claim 1, wherein:
the plurality of paying entities are subsidiaries of the single legal entity.

5. The method of claim 1, wherein:
each of the plurality of paying entities operates a storefront in a distinct jurisdiction; and
the common payee provides a good for sale by the storefronts of each of the plurality of paying entities.

6. The method of claim 5, wherein:
the common payee comprises a software developer; and
the good comprises software sold by each of the storefronts.

7. The method of claim 5, wherein:
the common payee comprises a game developer; and
the good comprises a game that can be played at least partially using an electronic device.

8. The method of claim 5, wherein:
the common payee comprises a publisher; and
the good comprises media.

9. The method of claim 8, wherein the media comprises at least one of an e-book, interactive media, audio, and video.

10. The method of claim 1, further comprising:
providing a payment from each of the plurality of payment entities to the payment processing entity in the determined amount.

11. The method of claim 7, wherein:
providing a payment from each of the paying entities further comprises providing a payment from each of the paying entities in currencies associated with each of the paying entities.

12. The method of claim 11, further comprising:
directing the paying processing entity to convert the provided payments from the currencies associated with each of the paying entities to a single currency.

13. The method of claim 12, wherein:
the single currency comprises at least one of a default currency and a currency associated with the common payee.

14. A method for providing payment to a payee from a plurality of entities to a single payee, comprising:
receiving with an automated processing system, for each of a plurality of related paying entities, an amount due to a single payee, wherein the related paying entities are controlled by a common legal entity;
aggregating the received amounts with the automated processing system to determine the total amount due to the single payee using a payment processing entity, wherein the payment processing entity is not controlled by the common legal entity; and
providing a payment in the total amount to the single payee with the automated processing system.

15. The method of claim 14, further comprising:
receiving a payment from each of the plurality of paying entities; and
transferring the received payment to the single payee.

16. The method of claim 15, further comprising:
receiving a payment from each of the plurality of paying entities further comprises receiving a payment from each of the plurality of entities in different currencies; and
converting the received payments from the different currencies to a single currency.

17. The method of claim 16, wherein:
the single currency is a currency associated with the single payee.

18. The method of claim 14, wherein:
each of the plurality of entities operates a storefront for selling content; and
the payee comprises a publisher providing content for sale by the plurality of entities in at least one of the storefronts.

19. The method of claim 18, wherein the content comprises at least one of:
a software application, interactive media, audio, video, e-books, and a key for accessing content.

20. A system for providing payments from a plurality of paying entities to a plurality of payees, comprising:
a plurality of paying entities, wherein the plurality of paying entities are controlled by a single entity;
a plurality of payees, wherein at least two of the plurality of paying entities owe payments to one of the plurality of payees; and
a payment processing entity that is not controlled by the single entity, the payment processing entity comprising a processor operative to:
receive, from each of the plurality of payees, an amount due to each of the plurality of payees;
aggregate the received amounts to determine a total amount due to each of the plurality of payees; and
provide a single payment to each of the plurality of payees in the determined total amount due to each of the plurality of payees.

21. The system of claim 18, wherein:
each of the plurality of paying entities is operative to provide a payment to the payment processing entity in the amount due by the paying entity to the plurality of payees; and
the processor of the payment processing entity is further operative to redirect the payments received from the plurality of paying entities to the appropriate payees.

22. The system of claim 21, wherein:
the payments provided by each of the plurality of paying entities are provided in at least two different currencies; and
the processor of the payment processing entity is further operative to convert the received payments associated with a particular payee from the at least two different currencies to a final currency.

23. The system of claim 22, wherein:
the final currency is selected by the particular payee.

24. The system of claim 18, wherein:
the plurality of paying entities comprises a plurality of entities each operating a storefront in different jurisdictions; and
the plurality of payees comprises a plurality of developers providing software to the plurality of paying entities for selling in the storefronts.

25. The system of claim 24, wherein:
the plurality of payment entities are operative to:
determine the value of sales for software sold by each of the plurality of developers;
determine a percentage amount of the determined sales value for each of the plurality of developers; and
provide the determined percentage amount to the payment processing entity as the amount to each of the developers.
